(19) United States
(12) Patent Application Publication
(10) Pub. No.: US 2006/0236572 A1
(43) Pub. Date: Oct. 26, 2006

(54) Ornamental writing board

(76) Inventor: Jung-Kuei Ko, Kaohsiung (TW)

Correspondence Address: JUNG-KUEI KO, 235 Chung-Ho, Box 8-24, Taipei, TW

(21) Appl. No.: 11/111,619

(22) Filed: Apr. 22, 2005

(51) Int. Cl. G09F 11/18

(52) U.S. Cl. 40/478

(57) ABSTRACT

An ornamental writing board having the ornamental function of a picture comprises a board surface, a roll-up curtain, a frame surrounding the roll-up curtain and a pair of scrolls. The frame consists of a frame seat and a plurality of frame surfaces that can be easily replaced. The scrolls are hidden behind two opposite frame surfaces, wherebetween the roll-up curtain situates. The roll-up curtain is subsequently connected picture, projection screen and soft plastic writing board of scrolling type, whereby the ornamental writing board can appear as an ornamental device or another writing device when the original writing board is not being using. The ornamental writing board can be further equipped with lights to make the picture more visually appealing.

### FIELD OF THE INVENTION

The present invention relates to writing boards (such as blackboards and whiteboards), more particularly to an ornamental writing board having an easily changeable frame for ornamental purposes. The ornamental writing board comprises a board surface, a roll-up curtain, a frame surrounding the roll-up curtain and a pair of scrolls. The frame consists of a frame seat and a plurality of frame surfaces that can be easily replaced. The scrolls are hidden behind two opposite frame surfaces, wherebetween the roll-up curtain situates. The roll-up curtain is subsequently connected picture, projection screen and soft plastic writing board of scrolling type, whereby the ornamental writing board can be used as an ornamental device or another writing device when the original writing board is used. The ornamental writing board can be further equipped with lights to make the picture it shows more visually appealing.

### BACKGROUND OF THE INVENTION

Writing boards of the prior art, blackboards or whiteboards, are widely used in schools, other government or civic organizartions for instructional purposes. They are either fixed on walls or on brackets. The writing boards are used with a groove in a lower portion thereof for placing chalks and collecting ashes. The writing boards of the prior art occupy space when not used, no matter hanging on walls or being stored in storage rooms.

The inventor has disclosed an ornamental writing board (U.S. Pat. No. 6,817,124). The ornamental writing board does not have a well round structural consideration and therefore is less practical. For example, the previous invention does have the ornamental function of a wall picture but does not have a practical design of its frame.

### SUMMARY OF THE INVENTION

The primary objective of the present invention is to provide an ornamental writing board comprises a board surface, a roll-up curtain, a frame surrounding the roll-up curtain and a pair of scrolls. The frame consists of a frame seat and a plurality of frame surfaces that can be easily replaced. The secondary objective of the present invention is to provide a ornamental writing board wherein the scrolls are hidden behind two opposite frame surfaces, between which the roll-up curtain situates. The roll-up curtain is subsequently connected picture, projection screen and soft plastic writing board of scrolling type, whereby the ornamental writing board can appear as an ornamental device or another writing device when the original writing board is not being using. The third objective of the present invention is to provide an ornamental writing board further equipped with lights to make the picture more visually appealing.

The present invention has the advantages of: being a wall picture, when the writing function of the board is not used; being a projection screen for a m projector, when the writing function of the board is not used; being a soft plastic writing board of scrolling type, when the writing function of the board is not used; being more practical; being more valuable; being more competitive in the market.

The various objects and advantages of the present invention will be more readily understood from the following detailed description when read in conjunction with the appended drawings.

### BRIEF DESCRIPTION OF THE DRAWINGS

FIG. 1 is a front view of an ornamental writing board according to the present invention.

FIG. 2 is a right side view of the ornamental writing board in FIG. 1 FIG. 3 is a top view of the ornamental writing board in FIG. 1.

FIG. 4 is a 4-4 cross-sectional view of the ornamental writing board in FIG. 1.

FIG. 5 is a 5-5 cross-sectional view of the ornamental writing board in FIG. 1.

FIG. 6. is a side view of a flexible piece of the ornamental writing board in FIG. 1.

FIG. 7 is a front view of the flexible piece in FIG. 6.

FIG. 8 is an 8-8 cross-sectional view of the ornamental writing board in FIG. 1.

FIG. 9 is a 9-9 cross-sectional view of the ornamental writing board in FIG. 1.

FIG. 10 illustrates the opening of a frame surface of the ornamental writing board in FIG. 1.

FIG. 11 illustrates the closing of a frame surface of the ornamental writing board in FIG. 1.

FIG. 12 is a cross-sectional view of a scroll of the ornamental writing board in FIG. 1.

FIG. 13 is a cross-sectional view of another scroll of the ornamental writing board in FIG. 1.

FIG. 14 illustrates the ornamental use of ornamental writing board in FIG. 1.

FIG. 15 illustrates the use of the ornamental writing board in FIG. 1 as a screen for projectors.

### DETAILED DESCRIPTION OF THE PREFERRED EMBODIMENTS

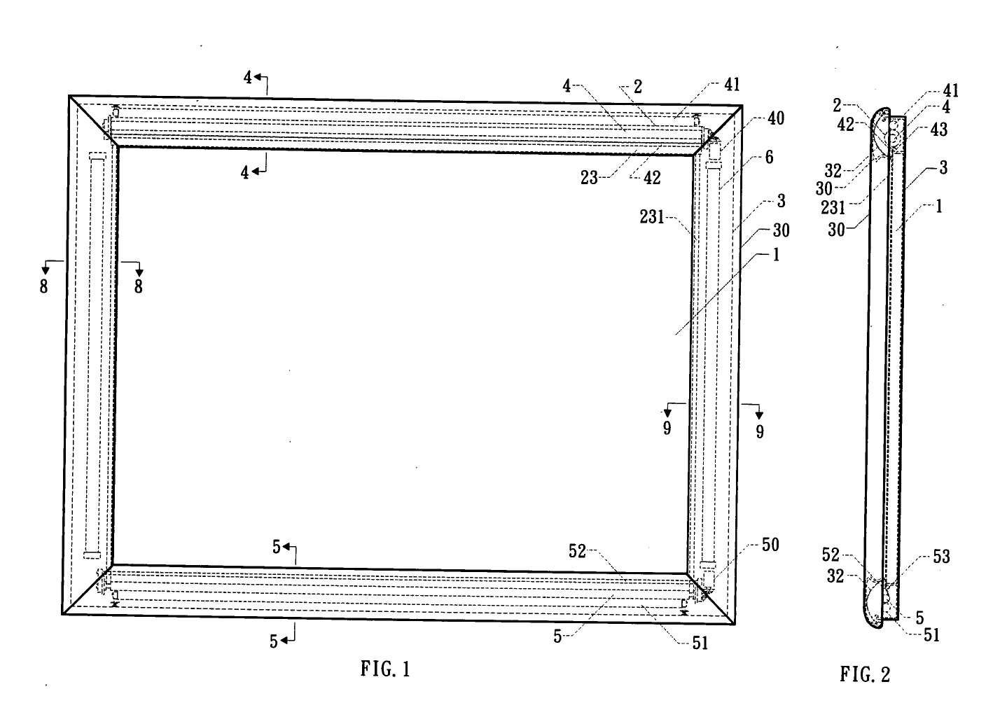

Referring to FIGS. 1 and 2, an ornamental writing board according to the present invention comprises a board surface 1, roll-up curtain 2, a frame 3, a scroll 4 and another scroll 5. The roll-up curtain 2 further comprises subsequently connected picture 20, projection screen 21 and soft plastic writing board of scrolling type 22.

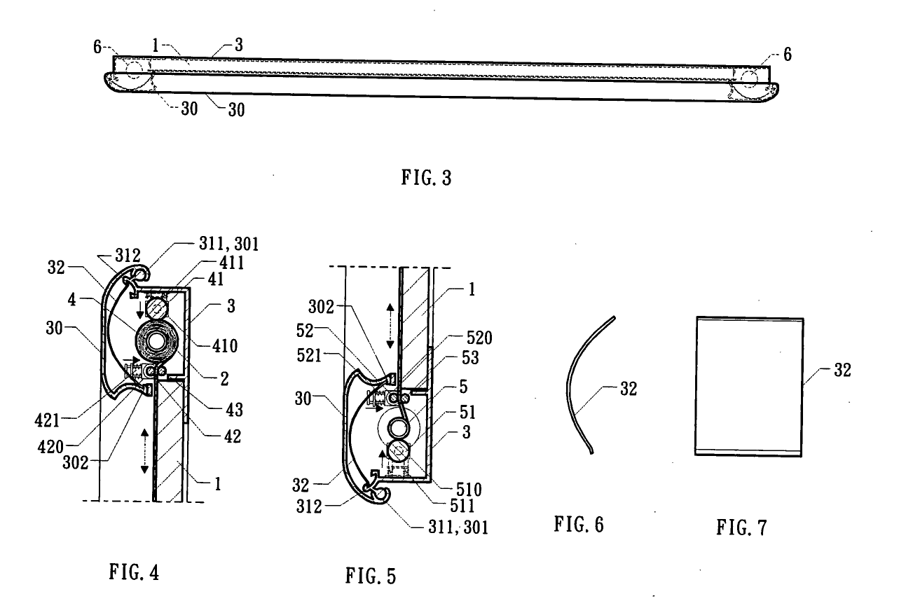

Referring to FIGS. 4, 5, 8 and 9, the board surface 1 is surrounded by the frame 3, which frame 3 is provided with a wedge matching piece 311 for the installation of a wedge trough 301 to the frame surfaces 30. The frame surfaces 30 are provided with ornamental patterns and are made of metallic materials (such as aluminum alloys) or non-metallic materials (such as wood, plastic). A plurality of flexible pieces 32 is sandwiched by the frame 3 and the frame surfaces 30, as shown in FIGS. 6 and 7. One end of each of the flexible pieces 32 is disposed in the trough 312 of the frame 3, and the other end of each of the flexible pieces 32 is disposed in the trough 302 of one frame surface 30. The frame surface 30 is capable of closing on or separating from the frame 3, by mean of the wedge matching pieces 311 and the wedge troughs 301. Thereby, the frame surface 30 of the frame 3 can be easily replaced.

Two opposite frame surface 30 of the frame 3 are equipped with the scroll 4 and the scroll 5 therein. The outer lateral sides of the scroll 4 and the scroll 5 are respectively provided wit elastic shafts 41 and 51. The scroll 4 and the scroll 5 are respectively rotationally mounted within the bearing mounts of sustaining seat 410 and 510. The pressurized engagement between the sustaining seats 410, 510 and the scrolls 4. 5 are respectively realized by springs 411 and 511. Further, the inner lateral sides of the scrolls 4 and 5 are respectively provided with two pairs of pressing rods 42, 43 and pressing rods 52 and 53, wherein the pressing rods 42, 52 are mounted on their two sides within the bearing mounts of sustaining seats 420, 520. The pressurized engagement between the sustaining seats 420, 520 and the scrolls 4. 5 are respectively realized by springs 421 and 521. Thereby, the contraction and extension of the scrolls 4 and 5 with any length can be easily done.

There is a roll-up curtain 2 rotationally mounted on and extended between the scrolls 4 and 5. The roll-up curtain 2 comprises subsequently connected picture 20, projection screen 21 and soft plastic writing board of scrolling type 22. The front edge of the roll-up curtain 2 is provided with a guiding member 23, which is connected from scroll 4 to the scroll 5 through a bracing cord 231. The bracing cord 231 is hidden within the frame 3 when the roll-up curtain 2 is not being adjusted.

The scrolls 4 and 5 respectively further include scrolling components 40 and 50; the scrolling components 40 and 50 can scroll the scrolls 4 and 5 in a stepless fashion; the scrolling components 40 and 50 can be attached to a motor or another manual means for achieving a stepless rotation. Further, an automatic sensing device, such as photoelectric cells capable of sensing distance or light shielding, can be added to assist the position control of the roll-up curtain 2. The control mechanism of the automatic sensing device can be selected from a manual and a remote control. When the width of the roll-up curtain 2 is larger than the width of the frame 3, the position control means does not needed.

Referring to FIGS. 12 and 13, the scroll 4 and the scroll 5 are hollow tubular bodies. The scroll 4 is provided with a slit 401 for embedding a fastening stick 24 of the roll-up curtain 2 therein. The scroll 5 is provided with a slit 501 for receiving the guiding member 23 of the roll-up curtain 2. Moreover, along one side of each of the slit 401 and the slit 501 there forms an oblique fringe 402 or a oblique fringe 502 for a flat scrolling of the roll-up curtain 2 whereby marks of uneven scrolling on the roll-up curtain 2 will not occur.

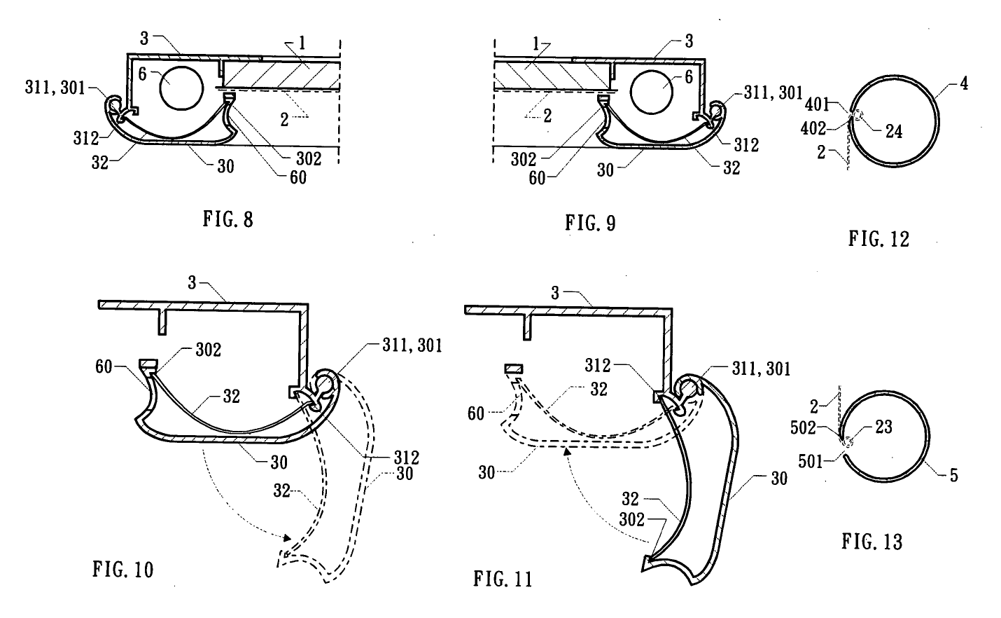

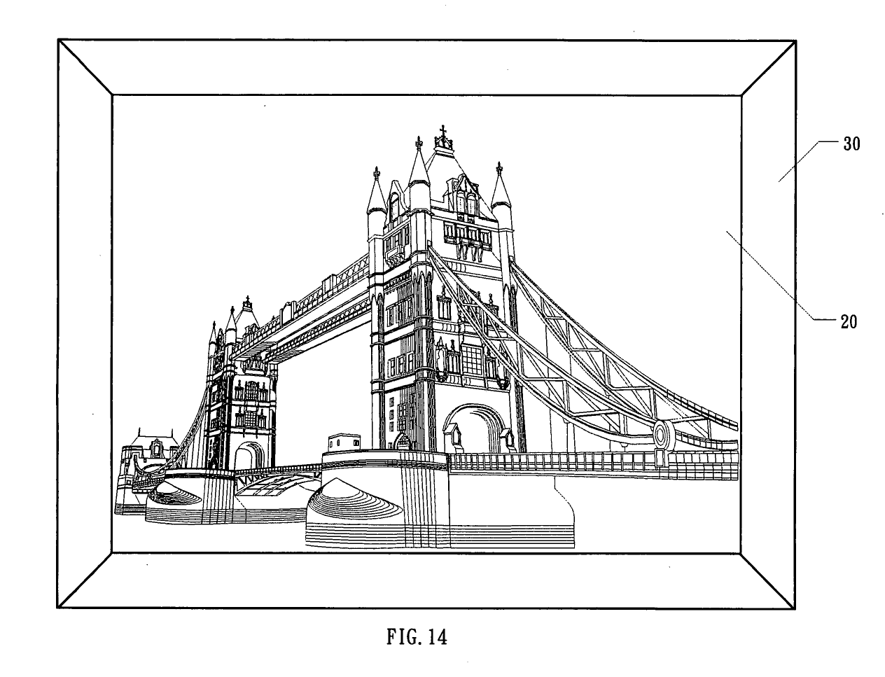

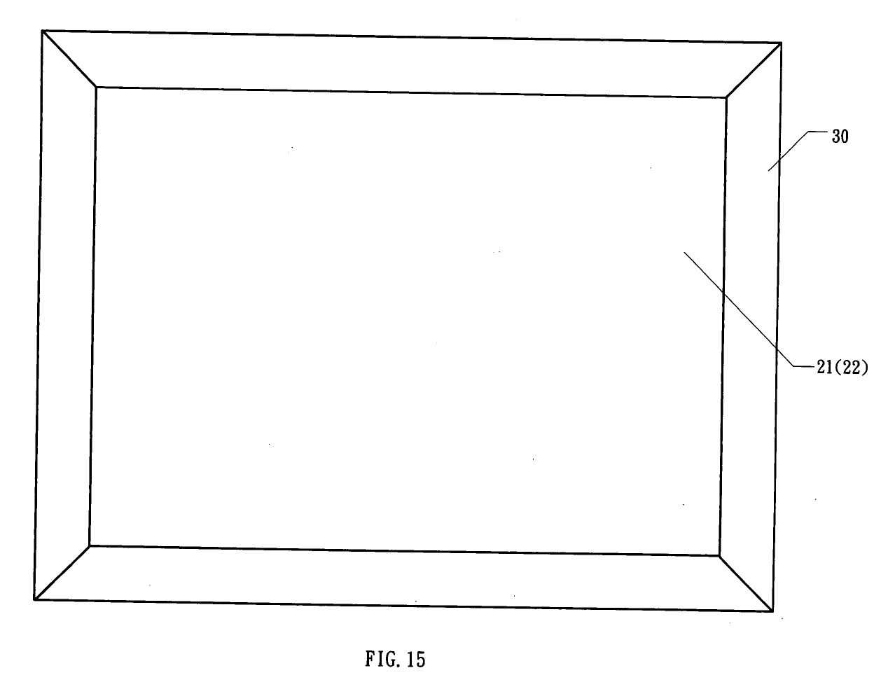

The inner sides of an opposite pair of frame surfaces 30 of the frame 3 are further equipped with lighting devices 6, as shown in FIGS. 8 and 9. The lighting devices 6 can be regular bulbs or LEDs (light emitting diodes) and emit lights though light emitting slits 60 to achieve the desired visual effect.

To use the ornamental writing board as an ornamental device, the board surface 1 can be occupied by a picture 20, a projection screen 21 or a soft plastic writing board of scrolling type 22, whereby the conventional, bad visual appeal of a writing blackboard and whiteboard can be removed.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An ornamental writing board, comprising:
a board surface;
a frame further comprise frame surfaces capable of being closed on and separated from said frame;
a pair of scrolls mounted on inner sides of a pair of opposite frame surfaces, each having an elastic shaft flexibly attached to said scrolls, said scrolls having respective pressing rods located on two inner lateral sides thereof; and
a roll-up curtain rotationally mounted within at least one scroll, said roll-up curtain is provided with a guiding member along a front edge thereof, two ends of said guiding member being pulled and connected to the other scroll by a pair of bracing cords.

2. The ornamental writing board of claim 1 wherein an outer lateral side of the frame seat of said frame is provided with a set of wedge matching pieces for engaging with corresponding wedge troughs of said scrolls; a plurality of flexible pieces being sandwiched by said frame and said frame surfaces; one end of each of said flexible pieces being disposed in said trough of said frame, the other end of each of said flexible pieces being disposed in a trough of one frame surface.

3. The ornamental writing board of claim 1 wherein said frame surfaces are attached to said frame by the engagement between said wedge matching pieces and said wedge troughs, whereby said frame surfaces can be easily replaced.

4. The ornamental writing board of claim 1 wherein each of said elastic shafts has its two ends retained within bearing mounts of a corresponding said scroll, whereby said elastic shafts exert a suitable pressing against respective said scrolls.

5. The ornamental writing board of claim 1 wherein an inner side of each of said scrolls is provided with two pressing rods, at least one of said pressing rods being retained between said bearing mounts of a said scroll; the elastic pressing between each of said pressing rods being controlled by a spring.

6. The ornamental writing board of claim 1 wherein said scroll are hollow tubular bodies each provided with a slit for respectively retaining a fastening stick of said roll-up curtain therein and said guiding member of said roll-up curtain; moreover, along one side of each of said slits there forming an oblique fringe for a smooth extension of said roll-up curtain whereby marks of uneven scrolling on said roll-up curtain will not occur.

7. The ornamental writing board of claim 1 wherein inner sides of an opposite pair of said frame surfaces of said frame are further equipped with lighting devices, selected from regular bulbs and fluorescent tubes, said lighting devices emitting lights though light emitting slits of said frame to achieve the desired visual effect.

8. The ornamental writing board of claim 1 wherein said extendable roll-up curtain comprises at least one picture.

9. The ornamental writing board of claim 1 wherein said roll-up curtain is subsequently connected picture, projection screen and soft plastic writing board of scrolling type.
